(19) United States
(12) Patent Application Publication
(10) Pub. No.: US 2003/0059518 A1
(43) Pub. Date: Mar. 27, 2003

(54) Meat broth-infused soy pieces and process for producing the same

(76) Inventors: Andrew Miller, Carmel, IN (US); Aaron Noveshen, San Francisco, CA (US); Marianne Paloncy, Mill Valley, CA (US)

Correspondence Address: BAKER & DANIELS, 300 NORTH MERIDIAN STREET, SUITE 2700, INDIANAPOLIS, IN, 46204-1782, US

(21) Appl. No.: 09/952,984

(22) Filed: Sep. 14, 2001

(51) Int. Cl. A23L 1/20

(52) U.S. Cl. 426/634

(57) ABSTRACT

A process for preparing a soyfood product by infusing dehydrated soy pieces with a meat broth until the dehydrated soy pieces absorb the meat broth to form meat broth-infused soy pieces. In a preferred embodiment, the meat broth-infused soy pieces are prepared by combining dehydrated soy pieces with a meat broth, bringing the combined dehydrated soy pieces and meat broth to a boil, and simmering the combined dehydrated soy pieces and meat broth until the meat broth is absorbed into the soy pieces. In another aspect, a food entree is prepared by combining the meat broth-infused soy pieces with a sauce base and, if desired, a vegetable blend.

### FIELD OF THE INVENTION

The present invention relates to foods containing soy and processes for preparing such foods. More particularly, the present invention relates to processes for preparing meat broth-infused soy pieces and soyfood entrées containing meat broth-infused soy pieces.

### BACKGROUND OF THE INVENTION

In the past, soy was considered to be a low-cost filler material, often used to extend the quantity of food products such as meat. However, it is now recognized that soy is high in nutrition and offers numerous health benefits. Unfortunately, soy has a beany flavor that has been rejected by the average U.S. consumer. Consequently, many consumers are not taking advantage of the nutritional value and health benefits that soy has to offer.

Of these consumers, women are missing some especially advantageous benefits provided by soy. For instance, soybeans contain nutritionally significant amounts of isoflavones, which are thought to reduce the risk of osteoporosis by increasing bone density. The isoflavones in soybeans are also believed to reduce the risk of certain types of cancer, the second leading cause of death in the United States. Studies suggest that isoflavones interfere with certain enzymes and hormones that are believed to convert normal cells to cancer cells. These results are further supported by evidence showing that breast cancer mortality rates are lower in Asian countries where diets are rich in soy. Soy isoflavones are also believed to reduce the symptoms of menopause. Specifically, daily consumption of isoflavones may reduce the frequency and intensity of hot flashes. In fact, the Japanese language does not have a word that translates to “hot flash.” It is thought that due to the high consumption of soy in that country, Japanese women do not suffer from hot flashes or other symptoms associated with menopause.

Of benefit to all consumers, scientific studies have shown that soybeans and soyfoods play a role in reducing the risks of heart disease. For example, soybeans are extremely high in protein, offering a complete protein profile including nine (9) amino acids. These soy proteins have been shown to directly lower blood cholesterol when combined with a low-fat, low-cholesterol diet, thereby reducing the risk of heart disease, the leading cause of death in America. In addition, soy proteins help prevent arterial damage by inhibiting cholesterol oxidation and the growth of cells that form artery-clogging plaque.

Soybeans also serve as an excellent source of certain vitamins and minerals. More specifically, many soyfoods are rich in calcium, copper, magnesium and vitamin B. The calcium in soyfoods is easily absorbed and may help maintain calcium levels in bones. Of additional nutritional significance, soy also contains soluble fiber, which may help to regulate glucose-levels, thereby aiding in the treatment of diabetes. In addition to the nutritional value and health benefits, soy is abundant and economical.

Despite the nutritional value and health benefits of soy, the beany flavor of soyfood products has prevented its success in the mainstream U.S. market. Instead, soy has been used as an inexpensive meat extender or meat replacement to fight protein deficiency and malnutrition, and is commonly used in schools, nursing homes, penal institutions and other arenas where cost is an overriding concern. In addition, soyfoods have been successfully marketed to the segment of consumers who are willing to sacrifice taste for the long-term reward of good health. Such consumers may include vegetarians and health food extremists. To the average U.S. consumer, however, taste is the most important attribute. Therefore, the average U.S. consumer is not likely to make such a large sacrifice but rather is more likely to please the palate today and worry about the health consequences tomorrow.

Recently, several attempts have been made to take advantage of the health - benefits of soy. For example, soy has been mixed with meat to extend the meat, while maintaining some meat flavor and adding the benefits of soy. However, foods containing actual meat can be expensive to manufacture. The cost of meat, alone, diminishes the economic benefits of the abundant soybean source. Moreover, the manufacture of meat-containing foods requires U.S.D.A. regulatory inspection, which can also raise the cost of production. Soy has also been used in food products as a functional ingredient for such purposes as binding water. Nevertheless, the unpleasant taste of soy to the American palate has thwarted its acceptance by the average American consumer.

Consequently, attempts have been made to improve the flavor of soy by imparting a meat flavor to the soy. For example, dry meat flavoring has been added to moist soy in an effort to produce meat-flavored soy. This results in a piece of soy that merely has a thin coating of meat flavor. Once in the mouth of the consumer, the dry flavoring quickly dissolves leaving the consumer to chew a beany-flavored piece of soy. Therefore, a need remains for providing an affordable soyfood that appeals to average consumers and entices average consumers to incorporate soy and its health benefits into their daily lives.

### SUMMARY OF THE DISCLOSURE

A process for preparing a soyfood product is provided. In one aspect, the invention provides infusing dehydrated soy pieces with a meat broth until the dehydrated soy pieces absorb the meat broth to form meat broth-infused soy pieces. In a preferred embodiment, the infusing step is performed by combining the dehydrated soy pieces with a heated meat broth, bringing the combined dehydrated soy pieces and meat broth to a boil, and simmering the combined dehydrated soy pieces and meat broth until the meat broth is absorbed into the soy pieces.

Another aspect of the invention provides a process for preparing food entrées, which include meat broth-infused soy pieces. In one embodiment, the process includes combining the meat broth-infused soy pieces with a sauce base. In a further embodiment, a vegetable blend is also added to the sauce base and meat broth-infused soy pieces to form a food entree.

The invention also provides for placing the food entree in a microwavable container, and further, sealing and freezing the entree in the microwavable container.

Accordingly, one object of the invention is to provide a convenient food that provides the nutritional and health benefits of soy, yet also has a taste that is pleasing to the average consumer. These and other objects, advantages and features are accomplished according to the products and processes of the present invention.

### BRIEF DESCRIPTION OF THE DRAWINGS

FIG. 1 illustrates the process for producing the meat broth-infused soy pieces and for assembling the pieces into an entrée.

### DESCRIPTION OF THE PREFERRED EMBODIMENTS

For the purposes of promoting an understanding of the principles of the invention, specific language will be used to describe embodiments of the invention. It will nevertheless be understood that no limitation of the scope of the invention is thereby intended, such alterations and further modifications in the described embodiments and such further applications of the principles of the described invention therein being contemplated as would normally occur to one skilled in the art to which the invention relates.

If the soyfood does not taste good, consumers will not eat it, and therefore, will not derive the health benefits offered by soy. The present invention provides a way to incorporate the benefits of soy into the daily lives of mainstream consumers by providing a soy product that is tasty, convenient, easy to prepare, economical, and nutritional. It has been discovered that infusing soy with a meat broth results in a food product that tastes like a piece of meat. Moreover, products containing more than 3% raw meat or 2% cooked meat are subject to U.S.D.A. inspections and regulations. Meat broth, on the other hand, contains less than 2% meat, and therefore, is not subject to USDA regulations and inspections. Therefore, the process of the present invention is an economical way of thoroughly instilling meat flavor into soy. Before this invention, it has been impossible to replace meat with soy and still have a good tasting food.

According to one embodiment of the present invention, meat broth-infused soy pieces are produced by infusing dehydrated soy pieces with a meat broth until the meat broth is absorbed by the dehydrated soy pieces. The dehydrated soy pieces are commercially available and are typically used in vegetarian entrees and as a meat extender. The term infusing in this context means causing the dehydrated soy pieces to be permeated or saturated with meat broth thereby instilling the flavor of the meat broth throughout the soy pieces.

The broth is a meat flavored liquid that can be, formed by combining a meat base, water, and, if desired, seasoning. Any suitable proportions can be used. For example, the invention contemplates combining between about 1% and 12% meat base, 65% and 94% water, and 0.5% to 6% seasonings. In one particular embodiment, about 4% meat base, 94% water, and 2% seasoning is combined. The meat base-water mixture is then preferably heated to between about 165° F. to about 212° F. for about 10 to about 15 minutes. The meat base can be derived from any animal meat including beef, chicken, pork or seafood. The meat base is prepared by cooking meat, salt, seasoning and water to a highly concentrated form. Such meat bases are also known in the art and commercially available. Although the preferred meat broth is made with meat, it is also contemplated that the meat broth could be made by any conventional method using any conventional ingredients, such as meat bouillon and meat bone.

It is important to infuse the dehydrated soy pieces with broth,, as opposed to merely exposing the soy to solid meat, because the infusion process causes the broth to rehydrate the dehydrated soy pieces and completely permeate each dehydrated soy piece, thereby thoroughly flavoring the soy with the flavor of the broth. In addition, due to the fats and soluible proteins in the meat broth, infusing the soy pieces with meat broth may improve the texture of the soy, resulting in a soy piece that more closely resembles meat than that produced using conventional methods of rehydration.

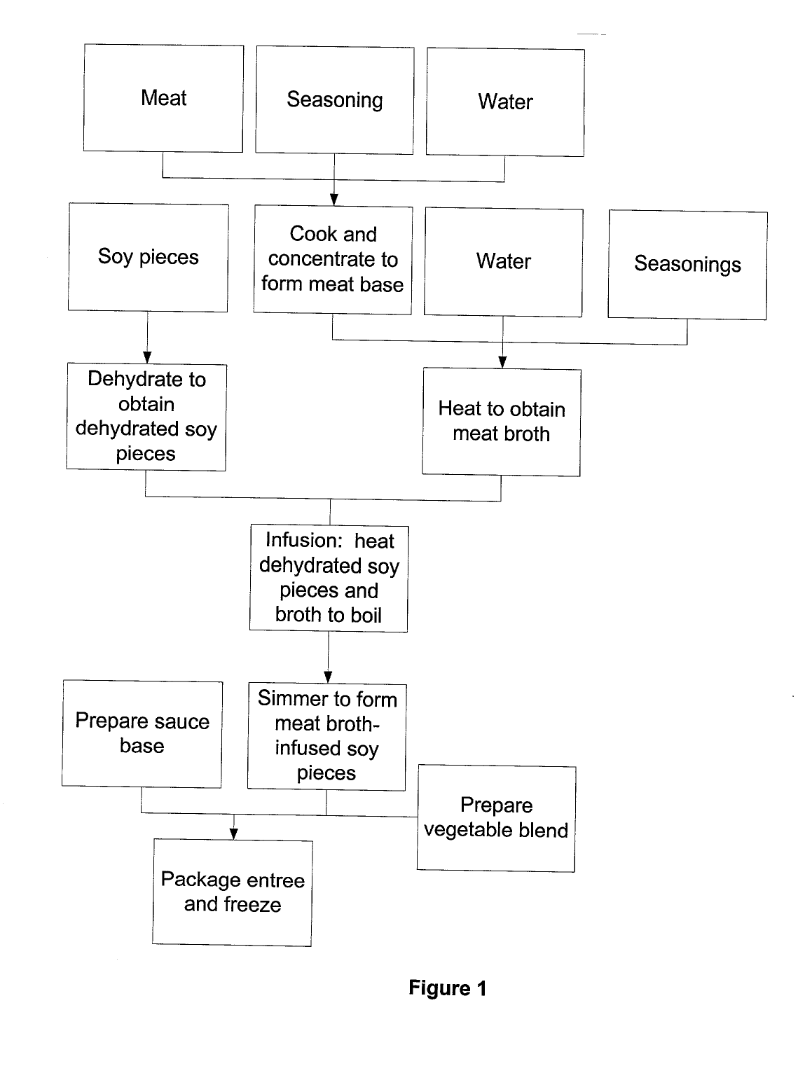

According to one aspect of the invention shown in FIG. 1, the dehydrated soy pieces are infused by first preparing and heating the meat broth to approximately 165° F. to about 212° F. with the most preferred temperature being about 195° F. The dehydrated soy pieces are then combined with the heated meat broth and the mixture is further heated to a boil. In another embodiment, the meat broth is brought to a boil before combining with the dehydrated soy pieces. Once the mixture reaches a boil, the heat is reduced to a low setting in the range of about 190° F. to about 200° F. The mixture is then covered and allowed to simmer until the meat broth is absorbed into the soy pieces, thereby forming meat broth-infused soy pieces. Preferably, each dehydrated soy piece will be completely saturated with meat broth. Depending on the nature and consistency of the broth, the simmering time can vary from about four minutes to about 40 minutes. This process results in each soy piece having an appealing meat flavor permeating throughout each soy piece. These flavorful soy pieces are appealing even to those consumers with the most discriminating taste.

In another embodiment, an entrée is produced by combining the meat broth-infused soy pieces with a sauce base. Such sauce bases are known in the art and can be prepared according to conventional methods. The sauce base comprises a variety of ingredients that are mixed and cooked to form a soup-like or sauce-like substance. Sauce base ingredients might include, for example, tomato paste, beef base, wine, mirepoix base, food starch, oil, garlic, onions and/or seasonings such as pepper, thyme, bay, oregano, cumin, rosemary and other seasonings. In some embodiments, the sauce base also includes meat broth and/or meat base. The broth/base can be prepared according to conventional methods or as described herein. In one particular embodiment, the meat broth is a Sea Clam Juice. In another specific aspect, the sauce base includes a beef base.

Preferably, the process of making the sauce base is performed separately from the process of making the meat broth-infused soy pieces. After producing the sauce base, the sauce base can combined with the meat broth-infused soy pieces, further enhancing the taste of the soy pieces and the entrée. Alternatively, the sauce base can be sealed, refrigerated, and stored for later assembly in an entrée.

In assembling an entrée of this invention, the sauce base is measured into a container followed by the meat broth-infused soy pieces. In one embodiment, the ratio of meat broth-infused soy pieces to sauce base is 1:2. The container is then sealed and the entrée is preferably frozen for later consumption. Preferably, the container will be a microwave-safe or oven-safe container so that a consumer can simply unwrap and heat the entrée in the container. The invention contemplates that the entrées of this invention will be packaged and frozen using conventional technology.

In another embodiment, an entrée is produced by combining meat broth-infused soy pieces with a sauce base and a vegetable blend. The meat broth-infused soy pieces, sauce base and vegetable blend are prepared separately. The vegetable blend is prepared by combining a selection of vegetables. The vegetables selected depend on the entrée ultimately produced. For example, if the ultimate entrée is a stew, vegetables such as carrots, tomatoes, mushrooms, and celery may be combined to form a complimentary vegetable blend. In other entrées, it may be desirable to have a mixture of different beans as a vegetable blend. Preferably the vegetables are IQF (Individually Quick Frozen) vegetables because IQF vegetables have excellent texture, nutrition and convenience. However, the invention also contemplates the use of fresh, frozen, dehydrated or canned vegetables. The vegetable blend can then be sealed and refrigerated or frozen for later assembly in an entrée.

As shown in FIG. 1, the entrée is assembled by first adding the sauce base to a container. Next, a vegetable blend is added to the container. And finally, the meat broth-infused soy pieces are added to produce the entrée. The container can then be sealed and the entrée frozen for later consumption.

The entrées of this invention are appetizing, healthy and convenient meals that are attractive even to the average consumer. The rich meat flavor of the meat broth-infused soy pieces entices average consumers to incorporate soy and its nutritional and health benefits into their daily lives. The consumers also benefit because they are consuming less meat. In addition, the manufacturing costs are maintained at a minimum because the entrées contain 2% or less meat, and therefore, are not subjected to U.S.D.A. regulations.

The following specific examples are provided-for purposes of illustrating the invention and no limitations on the invention are thereby intended.

### EXAMPLE 1

Preparation of Soy Pieces Infused With Beef Broth

First, a beef broth was prepared by combining, mixing and heating to about 100° C. (212° F.) water, beef base, and ground fennel seed. Dehydrated soy pieces were added to the heated beef broth and the mixture was brought to a boil (see Table I for ingredients and quantities). The heat was then reduced to about 88° C. (190° F.) and the mixture was simmered for approximately 20-30 minutes until the beef broth was absorbed into the soy pieces thereby rehydrating and infusing the soy pieces with the beef broth. The beef broth-infused soy pieces were allowed to cool and were then refrigerated for later use in an entrée.

TABLE I
Beef Broth-Infused Soy Pieces

| Ingredients | Quantity (%) |
|---|---|
| Water | 69.13 |
| Soy Pieces | 28.92 |
| Beef Base | 1.43 |
| Fennel Seed, Ground | 0.52 |
| | 100.00 |

### EXAMPLE 2

Preparation of a Tortellini Minestrone Entrée

First, beef-infused soy pieces were prepared according to Example 1. Next, a tortellini sauce base was prepared using the ingredients found in Table II. The dry ingredients were blended first to form a dry blend. In a separate container a starch slurry was prepared by mixing the starch with a portion of the water. While mixing, the dry blend was combined with the remaining water, tomato paste and beef base and such mixture was blended until smooth. The smooth mixture was then heated to about 91° C. (195° F.) and the remaining ingredients and starch slurry were added. The resulting mixture was boiled for approximately 5 minutes and then cooled.

TABLE II
Tortellini Sauce base

| Ingredients | Quantity (%) |
|---|---|
| Water | 54.26 |
| Diced Tomatoes, canned | 30.98 |
| Tomato paste | 5.48 |
| Beef base | 1.72 |
| Olive oil, extra virgin | 1.64 |
| Isolated Soy Protein | 1.64 |
| Modified Food Starch | 1.36 |
| Garlic, chopped, | 1.03 |
| Sugar | 0.69 |
| Salt | 0.43 |
| Basil, large chopped, | 0.36 |
| Parsley, large chopped, | 0.34 |
| Black pepper, | 0.05 |
| Citric acid | 0.03 |
| Soy Isoflavone | 0.00 |
| | 100.00 |

Next, two different vegetable blends were prepared. The first vegetable blend was prepared by combining mature soy beans, red kidney beans and spinach. The second vegetable blend was prepared by combining carrots, green beans and onions. Finally, the beef-infused soy pieces, sauce base and vegetable blends were combined to form an entrée. More specifically, about 152 grams of the sauce base was added to a microwavable/ovensafe container. Next, about 80 grams of the first vegetable blend and 31 grams of the second vegetable blend was added to the sauce base. Finally, the sauce base and vegetable blends mixture was topped with about 52 grams of beef broth-infused soy pieces, and 24 grams of tortellini to produce the tortellini minestrone entrée. The entrée was sealed and frozen for later consumption.

### EXAMPLE 3

Preparation of Soy Pieces Infused with Clam Broth

To make clam broth-infused soy pieces, a clam broth was prepared. Water, clam base, and sugar were combined and heated to about 100° C. (212° F.) to produce a clam broth (see Table III for ingredients and quantities). Dehydrated soy pieces were then added to the heated clam broth and the mixture was brought to a boil. The mixture was simmered on low heat to about 88° C. (190° F.) for about 20-30 minutes until the clam broth was absorbed by the soy pieces. The resulting clam broth-infused soy pieces were cooled, refrigerated and stored for later use in an entrée.

TABLE III
Clam Broth-Infused Soy Pieces

| Ingredients | Quantity (%) |
|---|---|
| Water | 73.80 |
| Soy Pieces | 22.36 |
| Clam Base | 3.58 |
| Sugar, granulated | 0.26 |
| | 100.00 |

### EXAMPLE 4

Preparation of a Clam-Flavored Chowder Entrée

First, clam broth-infused soy pieces were prepared according to Example 2. Next, a chowder sauce base was prepared with the ingredients found in Table IV. Specifically, the dry ingredients, with the exception of the starch, were blended. A starch slurry was then prepared by combining the starch with a portion of the water. While mixing, the pre-blended dry ingredients were combined with the remaining water, base, and liquids and were mixed until smooth. This smooth mixture was then heated to about 91° C. (195° F.) and the remaining ingredients and starch slurry were added. The resulting mixture was boiled for approximately 5 minutes to form a chowder sauce base. This chowder sauce base was cooled and stored for later use in the clam-flavored chowder entrée.

TABLE IV
Chowder Sauce base

| Ingredients | Quantity (%) |
|---|---|
| Water | 54.26 |
| 2% Lowfat milk | 17.15 |
| Sea Clam Juice—no MSG | 15.01 |
| Heavy cream | 4.29 |
| Soy Milk powder | 2.85 |
| Modified Food Starch | 2.61 |
| Chablis Cooking wine | 2.06 |
| Isolated Soy Protein | 1.39 |
| Mirepoix base | 0.95 |
| Clam Base | 0.95 |
| Nat. Clam Flavor | 0.19 |
| Cardia salt | 0.16 |
| Garlic puree, frozen | 0.12 |
| White pepper, ground | 0.06 |
| Parsley flakes, dehydrated | 0.05 |
| Xanthan Gum | 0.02 |
| Bay leaves, ground | 0.01 |
| | 100.00 |

A vegetable blend was made by combining celery, onions and corn. The clam-flavored chowder entrée was then assembled by first, adding 182 grams of the chowder sauce base to microwavable/ovensafe container. Next, about 51 grams of the vegetable blend and about 37 grams of potatoes were added. Finally, about 70 grams of the clam broth-infused soy pieces was added. The resulting clam flavored chowder entrée was then sealed and frozen for later consumption.

### EXAMPLE 5

Test Evaluating the Taste of the Entrée

In order to assess the present invention's taste and to predict its success, a concept versus product test was performed. In this test, participants evaluated a written product concept of the present invention by answering a series of questions. The participants then tasted prototype entrées of the present invention and reevaluated the concept after tasting. The results of the test are shown in Table V. As shown in Table V, before tasting the prototype, only 59% of the participating consumers were willing to purchase the product. However, after tasting the prototype, the consumers willingness to purchase the product increased by more than 10%, thus indicating that the prototype tasted better than the consumers expected. In fact, after tasting the product and being unable to distinguish the meat broth-infused soy pieces from actual meat, several consumers asked for identification of the soy part of the entrée.

TABLE V
Comparison of Pre-Product and Post Product Evaluations

| Willingness to Buy | Pre-Product (%) | Post-Product (%) |
|---|---|---|
| Definitely Would Buy | 12.7 | 30.8 |
| Probably Would Buy | 46.3 | 40.1 |
| | 59.0 | 70.9 |

### EXAMPLE VI

Taste Test Comparing Present Invention With Other Soy and Non-soy Products

A taste test was performed in which the participants blindly tasted three chili-type entrées and were asked which product they preferred. Product A was an embodiment of the of the present invention containing meat broth-infused soy pieces. Product B was a chili containing actual beef, and Product C was a vegetarian chili containing soy but no meat. The actual ingredients of each product is displayed in Table VI. One hundred percent of the participants preferred the taste of either Product A (an embodiment of the present invention) or Product B (the entrée containing actual meat). Not one participating consumer preferred the conventional soy product (Product C). This indicates that the participating consumers preferred the taste of the product of the present invention over the conventional soy product.

TABLE VI
Ingredients of Products Used in Taste Test

| Product | |
|---|---|
| Identification | Ingredients |
| A | water, red kidney beans, tomatoes, onions, soybeans, |
| | reduced fat mild cheddar cheese ({pasteurized part-skim |
| | milk, cheese culture, salt, enzymes, annatto [color], vitamin |
| | A palimitate}, cellulose powder), red bell peppers, |
| | texturized vegetable protein (soy protein concentrate, |
| | caramel color), seasoning/spices, tomato paste, beef base |
| | (beef, autolyzed yeast extract, salt, soy sauce [water, |
| | soybeans, wheat, salt], flavors), modified food starch, |
| | garlic, salt, natural flavor. |
| B | water, beef, beans, tomatoes (water, tomato paste), corn |
| | flour, salt, flavoring, chili powder (chili peppers, flavoring), |
| | sugar, modified food starch, green chiles, onions, jalapeño |
| | peppers. |
| C | filtered water, tomatoes, organic pinto beans, onions, soy |
| | protein, tomato paste, red bell peppers, green bell peppers, |
| | natural flavors (vegetable source, no msg), chili powder, |
| | honey, unsulfured molasses, red bell pepper concentrate, |
| | sea salt, shallot concentrate, garlic granules, natural beta |
| | carotene. |

While the invention has been described in detail in the foregoing description, the same is to be considered as illustrative and not restrictive in character, it being understood that only the preferred embodiments have been described and that all changes and modifications that come within the spirit of the invention are desired to be protected.

What is claimed:

1. A process for preparing a food product, comprising:
infusing dehydrated soy pieces with a meat broth until said dehydrated soy pieces are saturated with said meat broth to form meat broth-infused soy pieces.

2. A process for preparing a food product comprising:
infusing dehydrated soy pieces with a meat broth by providing said dehydrated soy pieces, combining said dehydrated soy pieces and said meat broth, bringing said dehydrated soy pieces and said meat broth to a boil, and simmering said dehydrated soy pieces and said meat broth until said soy pieces are saturated with said meat broth.

3. The process of claim 2, further comprising:
combining said meat broth-infused soy pieces with a sauce base.

4. The process of claim 3, further comprising:
combining said meat broth-infused soy pieces and said sauce base with a vegetable blend.

5. A process for preparing a food entrée, comprising:
infusing dehydrated soy pieces with a meat broth by providing said dehydrated soy pieces, combining said dehydrated soy pieces and said meat broth, bringing said dehydrated soy pieces and said meat broth to a boil, simmering said dehydrated soy pieces and said meat broth until said meat broth is absorbed into said soy pieces to form meat broth-infused soy pieces; and
combining a sauce base with said meat broth-infused soy pieces to produce an entrée.

6. The process of claim 5, further comprising adding said entrée to a microwavable container.

7. The process of claim 6, further comprising scaling and freezing said entrée in said microwavable container.

8. The process of claim 5, further comprising preparing a vegetable blend and combining said vegetable blend with said entrée.

9. A food product comprising dehydrated soy pieces saturated with a meat broth.

10. The product of claim 9 further comprising a sauce base mixed with said soy pieces.

11. The product of claim 10 wherein said sauce base includes meat broth and/or meat base.

12. The product of claim 10 further comprising a vegetable blend mixed with said soy pieces and said sauce base.

13. A food entrée, comprising:
meat broth-infused soy pieces, said meat broth-infused soy pieces produced by combining dehydrated soy pieces and a meat broth, bringing said dehydrated soy pieces and said meat broth to a boil, simmering said dehydrated soy pieces and said meat broth until said meat broth is absorbed into said soy pieces; and
a sauce base.

14. The entrée of claim 13 further comprising a vegetable blend.

15. The entrée of claim 13 wherein said sauce base includes meat broth and/or meat base.
